(19) United States
(12) Patent Application Publication
(10) Pub. No.: US 2003/0121553 A1
(43) Pub. Date: Jul. 3, 2003

(54) Structure faucet water diversion device

(76) Inventor: Hsiu-mei Kuo Liao, Sanchung City (TW)

Correspondence Address: Mr. Meng-Tsuey, Pan, P. O. Box 1-252, Sanchung City, TW

(21) Appl. No.: 10/286,928

(22) Filed: Oct. 30, 2002

(30) Foreign Application Priority Data
Dec. 31, 2001 (TW) 90224014

(51) Int. Cl. F16K 11/083

(52) U.S. Cl. 137/625.47; 137/625.4

(57) ABSTRACT

The invention is related to an improved faucet water diversion device which is mainly comprised of a body, wherein the said body includes a ring nut, a filtering spout, a water filtering unit, a water output coupling, a water input coupling and a revolvable liquid rechannelling shaft. The revolvable liquid rechannelling shaft is pivotally connected with the body, wherein the said shaft has formed a slotted plug on the end thereof so as to lock with a knob. A first bore and a second bore are provided on the said shaft; a first stepped through-hole and a second stepped through-hole are installed crosswise with the first and second bores respectively, wherein each of the through-holes and each of the bores is perpendicular to the axis of the revolvable liquid rechannelling shaft; emplaced inside each of the first and second stepped through-holes are a spring and a steel ball. When the knob is switched to make water flow into a filtration machine, one steel ball is capable of blocking the washer of filtering spout; or when a water purifier is not in use so water is directly utilized without the process of filtration, two steel balls are positioned on the washer of water filtering unit and on the ring washer of water output coupling that enables to fulfill dual functions on sealing up water.

### BACKGROUND OF THE INVENTION

1) Field of the Invention

The present invention is related to an improved structure faucet water diversion device which is characterized as dual functions on stopping flowing water and leakage to prevent the residual water in a water purifier from spilling over and to economize the use of water.

2) Description of the Prior Art

A conventional faucet water diversion device, as shown in FIGS. 9 and 10, is comprised of a body that has pivotally installed in it a revolvable liquid rechannelling shaft and has fastened a water output coupling and, furthermore, respectively installed to the upper and lower extent of the said body is a ring nut and a water filtering spout; installed on the said revolvable liquid rechannelling shaft is a steel ball and a spring. The said body consists of a cylindrical block having disposed in the center a stepped bore and in its lateral surface and contiguous with the said stepped bore is a threaded hole and a horizontal columnar passage that penetrates the said stepped bore, respectively enabling the threaded fastening of the said water output coupling and the pivotal installation of the said revolvable liquid rechannelling shaft with the horizontal columnar passage. The revolvable liquid rechannelling shaft consists of a round chambered column having a revolvable button-type handle situated at one side; the said column has disposed in a crisscrossed arrangement and also perpendicular to its axial center a through-hole and a stepped hole, and nested in the said stepped hole is the steel bail and the spring. The revolvable liquid rechannelling shaft is used to control the direction of the current flowing from the water filtering spout or the water output coupling by turning the said shaft into an upright or a horizontal position.

However, when the revolvable liquid rechannelling shaft of conventional diversion device is switched, the water output coupling or the water output opening are operationally obstructed by one steel ball. While the water output opening is blocked by the steel ball, the residual water in a water filter or a water purifier usually flows outwards from the small water filtering spout due to the stress of internal pressure which results in a waste of precious water; moreover, water seeping or leakage will occur as the steel ball or a rubber washer is worn.

### SUMMARY OF THE INVENTION

The objective of the invention herein is to provide a device with dual stopping functions on sealing up the water by obstructing the water filtering unit and the water output coupling in the meantime when the knob is switched to make water come out from the water filtering spout.

Another objective of the invention is to prevent the residual water in a water purifier or a water filter from seeping due to the stress of water pressure so as to economize the use of water.

The brief description of the drawings below is followed by the detailed description of the invention.

### BRIEF DESCRIPTION OF THE DRAWINGS

FIG. 1 is an elevation breakdown view of the present invention.

FIG. 2 is an assembled elevation view of the present invention.

FIG. 3 is a cross-sectional view on the line 3-3′ of FIG. 1.

FIG. 4 is a cross-sectional view on the line 4-4′ of FIG. 1.

FIG. 5 is a cross-sectional view when water flows out directly without filtering through the water output and input couplings linked with a water filter.

FIG. 6 is a cross-sectional view in another direction of FIG. 5.

FIG. 7 is a cross-sectional view when water is filtered through the water output and input couplings linked with a water filter.

FIG. 8 is a cross-sectional view in another direction of FIG. 7.

FIG. 9 is the elevation of the prior faucet water diversion device.

FIG. 10 is a sectional view on the line 10-10′ of FIG. 9.

### DETAILED DESCRIPTION OF THE INVENTION

The present invention can be best described in detail in conjunction with a better embodiment and the accompanied drawings as follows:

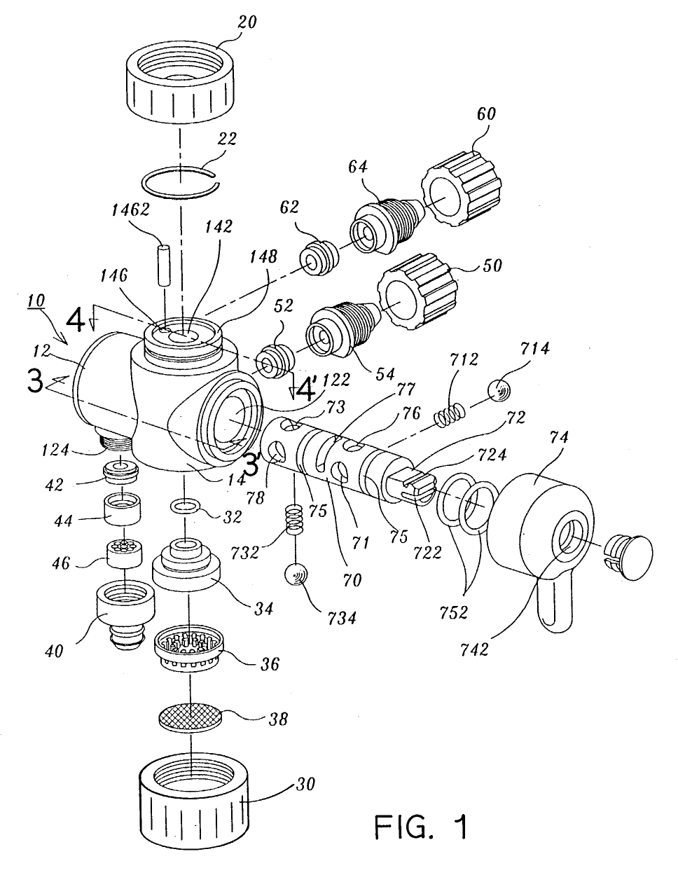

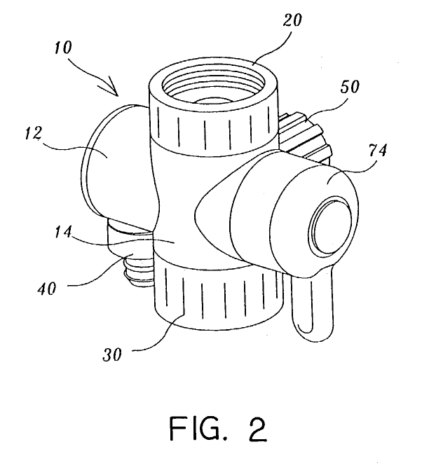

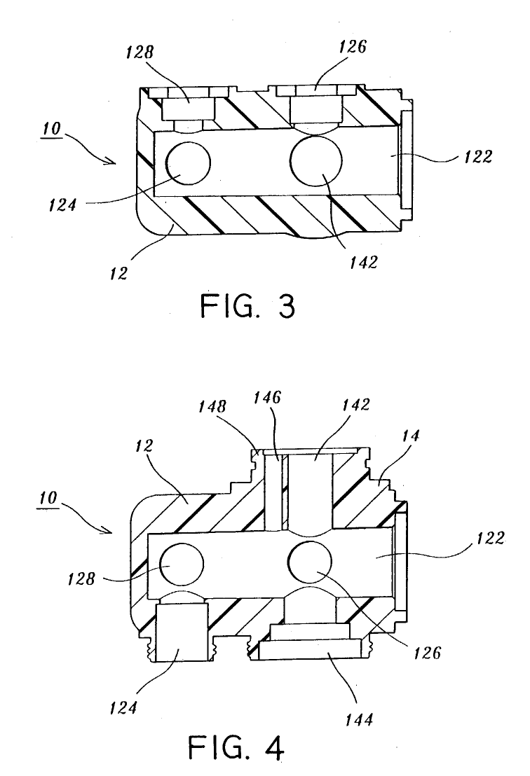

Referring to FIGS. 1 and 2, the present invention is mainly comprised of a body 10, wherein the body 10 consists of a horizontal columnar passage 12 and a vertical columnar passage 14 set in crisscrossed arrangement. As shown in FIGS. 3 and 4, the vertical columnar passage 14 has formed a center hole 142 on its upper side and a stepped hole 144 on its lower side, wherein both holes penetrate through the body of vertical columnar passage 14. A pinhole 146 is provided next to the center hole 142. One side of the horizontal columnar passage 12 is provided with a horizontal opening 122 and the other lower lateral side thereof is provided with a hole 124. A first set hole 126 and a second set hole 128 are respectively provided on the lateral side of the horizontal columnar passage 12. The center hole 142, the pinhole 146, the stepped hole 144, the hole 124, the first and second set holes 126, 128 all connect to the horizontal opening 122. Turning to FIGS. 1 and 2, the vertical columnar passage 14 has formed a protruding ring 148 on its upper side so as to interlock a C-shaped tensile ring 22 with a ring nut 20. A filtering spout 30 is fastened with the stepped hole 144. The filtering spout 30, as indicated in FIG. 1, consists of a washer 32, a mounting seat 34, a filter assembly 36 and a grilled filter 38. A water filtering unit 40 is fastened on the lower side of the hole 124, wherein the water filtering unit 40 is composed of a washer 42, an annular seat 44 and a perforated filter 46. A water output coupling 50 and a water input coupling 60 are respectively installed on the first and second set holes 126, 128. The water output coupling 50 includes a ring washer 52 and a threaded connector 54; the water input coupling 60 also includes a ring washer 62 and a threaded connector 64. A revolvable liquid rechannelling shaft 70 is pivotally connected with the horizontal opening 122. A slotted plug 72 is provided on the end of revolvable liquid rechannelling shaft 70, wherein the slotted plug 72, as shown in FIG. 1, consists of a groove 722 and a slot 724 to enable the assemblage of a knob 74. An axial hole 742 is set in the middle of the knob 74 and a protuberance 744, as indicated in FIG. 6, is installed inside the axial hole 742 that enables the conjoinment and fixation of the knob 74 with the slotted plug 72 by locking the protuberance 744 into the slot 724.

Referring to FIG. 1, the revolvable liquid rechannelling shaft 70 is a long shaft body, which has formed a first bore 76 and a second bore 78 thereon. A first stepped through-hole 71 and a second stepped through-hole 73 are installed crosswise with the first and second bores 76, 78 respectively, wherein each of the through-holes 71, 73 and each of the bores 76, 78 is perpendicular to the axis of the revolvable liquid rechannelling shaft 70; emplaced in the first and second stepped through-holes 71, 73 are springs 712, 732 and steel balls 714, 734. Two annular grooves 75 or more are provided on the revolvable liquid rechannelling shaft 70 for inserting two rubber rings 752 to tightly link such shaft 70 and the horizontal opening 122 together, thereby precluding the possibility of leakage. One curved groove 77 is provided on the revolvable liquid rechannelling shaft 70 that enables a pin 1462 to be positioned through the pinhole 146 into the curved groove 77 so as to make the said shaft 70 firmly situate in the horizontal opening 122 without deflection

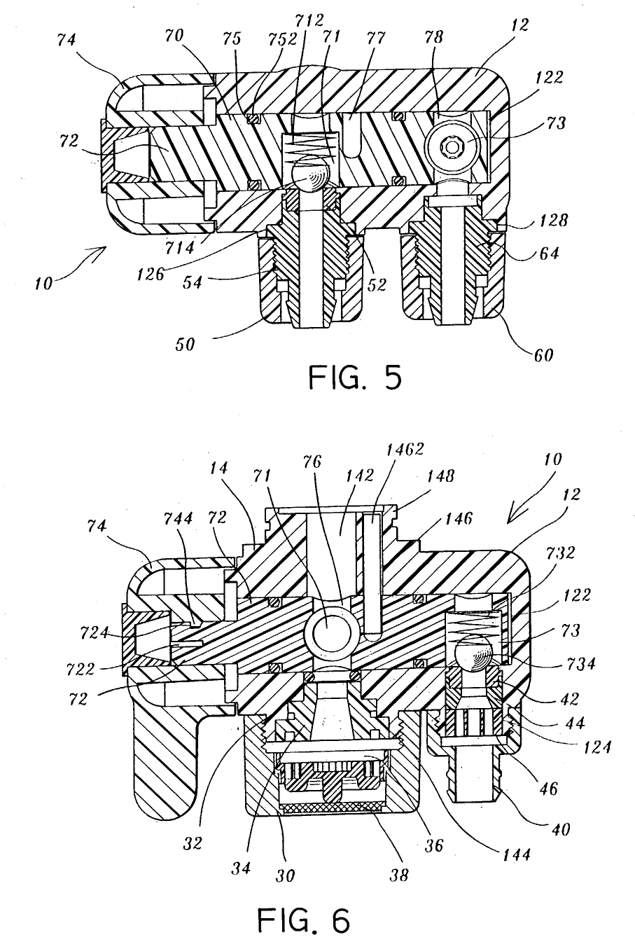

The water output and input couplings 50, 60 of the present invention are linked with a water filter or a water purifier by means of tubes and the ring nut 20 is fastened onto the water faucet. Turning to FIGS. 5 and 6, when the knob 74 turns into an upright position, the first and second bores 76, 78 on the revolvable liquid rechannelling shaft 70 are respectively aligned with the center hole 142 and the second set hole 128 so that water flows through the center hole 142, the stepped hole 144 and the filtering spout 30. In this case, two steel balls 714, 734 inside the first and second stepped through-holes 71, 73 are just positioned on the ring washer 52 of water output coupling 50 and on the washer 42 of water filtering unit 40 respectively that enables to fulfill dual functions on stopping water from running through the water output coupling 50 and through the water filtering unit 40, thereby guiding water to directly flow out from the filtering spout 30 for usage.

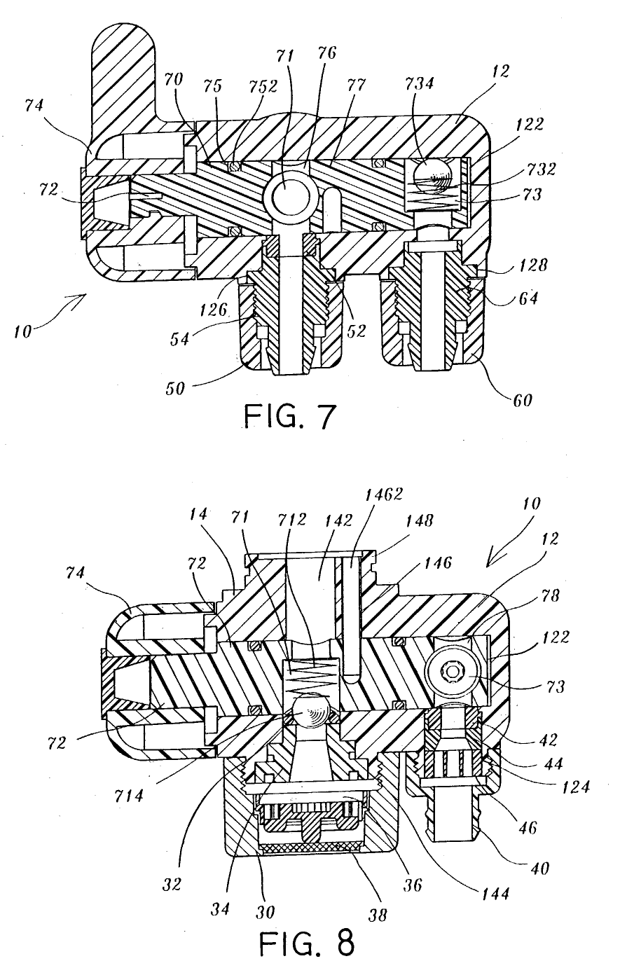

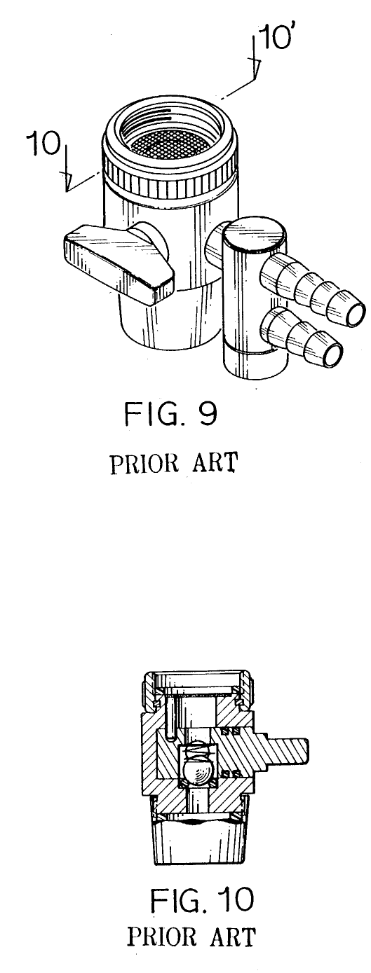

Referring to FIGS. 7 and 8, as the knob 74 turns into a horizontal position (at a 90 degree angle,) water flows into a water filter or a water purifier through the water output coupling 50; after the process of filtration, filtrated water flows into the body 10 through the water input coupling 60 and then filtrated water runs through the water filtering unit 40 for usage. Such process of filtration is carried out by removing the steel ball 734 inside the second stepped through-hole 73 from the washer 42 of water filtering unit 40 and by positioning the steel ball 714 inside the first stepped through-hole 71 upon the washer 32 of filtering spout 30 in order to block water from flowing through the filtering spout 30.

Finally, the faucet water diversion device of the invention herein has the distinguishing characteristics as follows: the revolvable liquid rechannelling shaft 70 includes a first bore 76 and a second bore 78 thereon; a first stepped through-hole 71 and a second stepped through-hole 73 are intersected with the first and second bores 76, 78 respectively and the said bores 76, 78 and the said through-holes 71, 73 are perpendicular to the axile center of revolvable liquid rechannelling shaft 70; disposed in the first and second stepped through-holes 71, 73 are springs 712, 732 and steel balls 714, 734, which enables to obstruct the washer of filtering spout 30 or to obstruct the washer 42 of water filtering unit 40 and the ring washer 52 of water output coupling 50 respectively by the mechanism of revolvable liquid rechannelling shaft 70. When people use water directly through the filtering spout 30 of present faucet water diversion device, it is capable of sealing up water with dual functions so that the filtrated water through a water filtration machine does not spill or leak from the water filtering unit 40 as the revolvable liquid rechannelling shaft 70 is switched to disconnect the water filtration machine by obstruction of steel balls, thereby preventing a waste of water due to leakage or seepage and further extending the time limit of replacing the filter cartridge inside a water filtration machine. In addition, when the washer 42 or the matching steel ball 734 is worn, the ring washer 52 and the steel ball 714 inside the first set hole 126 are still able to obstruct water without flowing into a water filtration machine through the water output coupling 50 and vice versa.

The above illustration is one better embodiment of this invention, so it is not limited to be carried out in such way. Any variation or modification which is based on the structure, form and features mentioned in the claims herein is involved within and subject to the scope of this application.

In conclusion, the invention herein is characterized as innovative, progressive and convenient for industrial utilization, which fulfills the patent requirements of Taiwan patent law and accordingly the US patent application is made to respectfully request that the application be allowed and the receipt of an early Notice of Allowance is courteously awaited.

1. An improved faucet water diversion device comprising:
a body including:
a horizontal columnar passage and a vertical columnar passage set in crisscrossed arrangement;
a center hole formed on the upper side of the vertical columnar passage and a stepped hole on the lower side thereof;
a horizontal opening penetrating through one side of the horizontal columnar passage and a hole provided on the other lower lateral side thereof;
a first set hole and a second set hole disposed on the lateral side of the horizontal columnar passage respectively;
a pinhole installed next to the center hole, wherein the said center hole, the pinhole, the stepped hole, the said hole, the first set hole and the second set hole all connect to the horizontal opening;
a protruding ring formed around the upper side of the vertical columnar passage;
a ring nut that enables to interlock with the said protruding ring by means of a C-shaped tensile ring;
a filtering spout fastened with the stepped hole, wherein the said filtering spout further comprises a washer disposed in the interior thereof;
a water filtering unit fastened on the lower side of the said hole, wherein the said water filtering unit is composed of a washer;
a water output coupling installed on the first set hole, wherein the water output coupling includes a ring washer and a threaded connector;
a water input coupling installed on the second set hole, wherein the water input coupling also includes a ring washer and a threaded connector;
a revolvable liquid rechannelling shaft pivotally connected with the horizontal opening, which further consists of:
a knob;
a slotted plug provided on the end of the revolvable liquid rechannelling shaft that enables the assemblage of the knob;
a first bore and a second bore formed on the said revolvable liquid rechannelling shaft;
a first stepped through-hole and a second stepped through-hole installed crosswise with the first and second bores respectively, wherein each of the said through-holes and the said bores is perpendicular to the axis of the revolvable liquid rechannelling shaft;
a spring and a steel ball disposed inside each of the first and second stepped through-holes; and
after the assemblage of above said components, one steel ball is able to obstruct the washer of filtering spout to make water filter through a water filter or two steel balls are capable of blocking the washer of water filtering unit and the ring washer of water output coupling respectively to utilize water without filtration when turning the revolvable liquid rechannelling shaft into a horizontal or an upright position.

2. The improved faucet water diversion device of claim 1 wherein said revolvable liquid rechannelling shaft has formed one curved groove that enables a pin to be positioned through the pinhole into the curved groove.

3. As mentioned in claim 1 wherein said filtering spout further includes a mounting seat, a filter assembly and a grilled filter.

4. The improved faucet water diversion device of claim 1 wherein said water filtering unit is further composed of an annular seat and a perforated filter.

5. The improved faucet water diversion device of claim 1 wherein said revolvable liquid rechannelling shaft is a long shaft body.

6. As mentioned in claim 1 and claim 5 wherein said revolvable liquid rechannelling shaft includes:
a groove and a slot disposed on the slotted plug of said shaft;
an axial hole set in the middle of the knob; and
a protuberance installed inside the axial hole that enables the conjoinment of the knob with the slotted plug by locking the protuberance into the slot.

7. As mentioned in claim 1 and claim 5 wherein said revolvable liquid rechannelling shaft has also formed two annular grooves or more for inserting two rubber rings to tightly link such shaft and tile horizontal opening together, thereby precluding the possibility of leakage.
